(19) United States
(12) Patent Application Publication
(10) Pub. No.: US 2024/0281359 A1
(43) Pub. Date: Aug. 22, 2024

(54) PREDICTIVE ANOMALY DETECTION AND FAULT ISOLATION IN INFORMATION PROCESSING SYSTEM ENVIRONMENT

(71) Applicant: Dell Products L.P., Round Rock, TX (US)

(72) Inventors: William Jeffery White, Plano, TX (US); Robert A. Lincourt, JR., Franklin, MA (US); Said Tabet, Austin, TX (US)

(21) Appl. No.: 18/112,256

(22) Filed: Feb. 21, 2023

(51) Int. Cl. G06F 11/34; G06F 11/30

(52) U.S. Cl. CPC G06F 11/3495; G06F 11/3006; G06F 11/3409; G06F 2201/875

(57) ABSTRACT

Application monitoring techniques comprising predictive anomaly detection and fault isolation are disclosed for use in an information processing system environment. For example, an apparatus comprises at least one processing device comprising a processor coupled to a memory. The processing device is configured to obtain application-level data generated for an information processing system in accordance with execution of an application and obtain hardware-level data generated for the information processing system in accordance with the execution of the application. The processing device is further configured to utilize an unsupervised machine learning model to predictively detect anomalous behavior in accordance with the execution of the application in the information processing system, based on at least a portion the application-level data and the hardware-level data. The processing device may also initiate fault isolation in addition to predicting anomalous behavior.

### FIELD

The field relates generally to information processing, and more particularly to techniques for managing information processing systems.

### BACKGROUND

Information processing systems that execute application programs or, more simply, applications, are increasingly deployed in a distributed manner. For example, processing of application tasks may occur on different computing devices that can be distributed functionally and/or geographically. The information processing system environment may also have a large amount of computing devices and, overall, process a vast amount of data. Nonetheless, applications may still need to efficiently execute and, in many cases, must meet certain objectives. While anomalies and/or faults in the information processing system environment can significantly hamper such objectives, they can be difficult to detect and/or isolate when the information processing system environment is distributed in nature.

### SUMMARY

Illustrative embodiments provide application monitoring techniques comprising predictive anomaly detection and fault isolation for use in an information processing system environment.

In one embodiment, an apparatus comprises at least one processing device comprising a processor coupled to a memory. The processing device is configured to obtain application-level data generated for an information processing system in accordance with execution of an application and obtain hardware-level data generated for the information processing system in accordance with the execution of the application. The processing device is further configured to utilize an unsupervised machine learning model to predictively detect anomalous behavior in accordance with the execution of the application in the information processing system, based on at least a portion the application-level data and the hardware-level data. The processing device may also initiate fault isolation in addition to predicting anomalous behavior.

These and other illustrative embodiments include, without limitation, methods, apparatus, networks, systems and processor-readable storage media.

### BRIEF DESCRIPTION OF THE DRAWINGS

FIG. 1 illustrates an information processing system environment configured with application monitoring functionalities according to an illustrative embodiment.

FIG. 2 illustrates an exemplary application monitoring process for predictive anomaly detection and fault isolation according to an illustrative embodiment.

FIG. 3 illustrates an exemplary predictive anomaly detection transformer algorithm according to an illustrative embodiment.

FIG. 4 shows a process flow for application monitoring with predictive anomaly detection and fault isolation according to an illustrative embodiment.

FIGS. 5 and 6 illustrate examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud and edge computing and storage systems, as well as other types of processing systems comprising various combinations of physical and virtual processing resources.

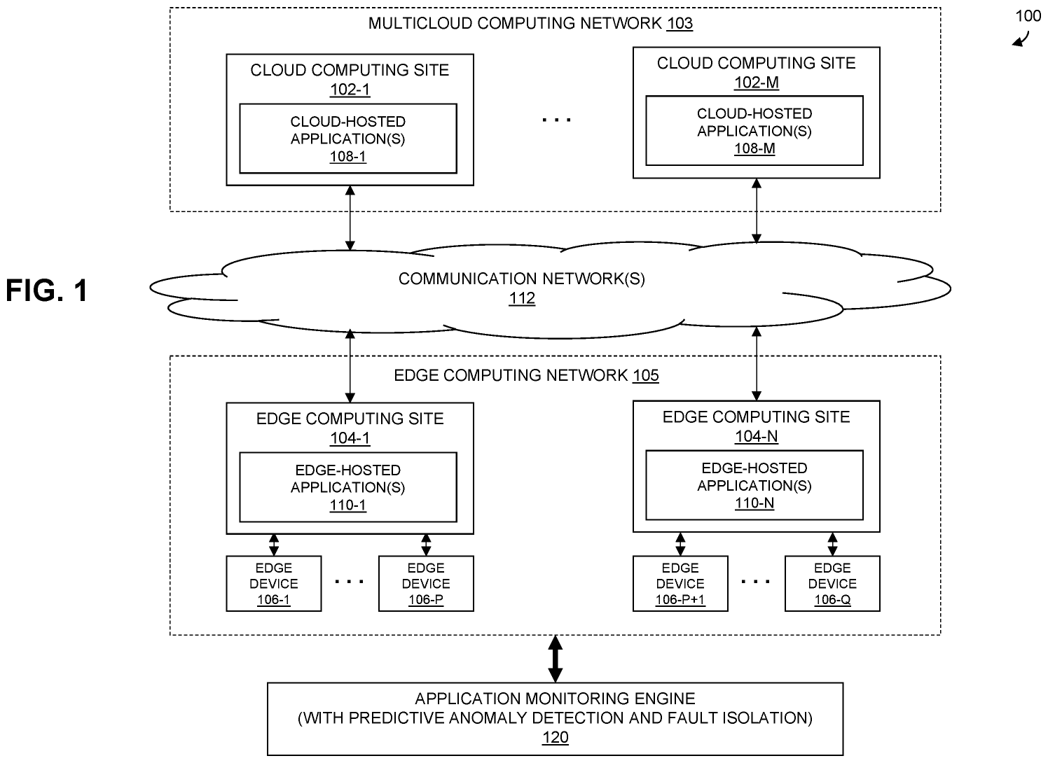

FIG. 1 shows an information processing system environment 100 configured in accordance with an illustrative embodiment. The information processing system environment 100 is illustratively assumed to be implemented across multiple processing platforms and provides functionality for application monitoring with predictive anomaly detection and fault isolation as will be further described below.

The information processing system environment 100 comprises a set of cloud computing sites 102-1, . . . 102-M (collectively, cloud computing sites 102) that collectively comprise a multicloud computing network 103. Information processing system environment 100 also comprises a set of edge computing sites 104-1, . . . 104-N(collectively, edge computing sites 104, also referred to as edge computing nodes or edge servers 104) that collectively comprise at least a portion of an edge computing network 105. The cloud computing sites 102, also referred to as cloud data centers 102, are assumed to comprise a plurality of cloud devices or cloud nodes (not shown in FIG. 1) that run sets of cloud-hosted applications 108-1, . . . . 108-M (collectively, cloud-hosted applications 108). Each of the edge computing sites 104 is assumed to comprise compute infrastructure or edge assets (not shown in FIG. 1) that run sets of edge-hosted applications 110-1, . . . 110-N(collectively, edge-hosted applications 110). As used herein, the term “application” is intended to be broadly construed to include applications, microservices, and other types of services.

Information processing system environment 100 also includes a plurality of edge devices that are coupled to each of the edge computing sites 104 as part of edge computing network 105. A set of edge devices 106-1, . . . 106-P are coupled to edge computing site 104-1, and a set of edge devices 106-P+1, . . . 106-Q are coupled to edge computing site 104-N. The edge devices 106-1, . 106-Q are collectively referred to as edge devices 106. Edge devices 106 may comprise, for example, physical computing devices such as Internet of Things (IoT) devices, sensor devices (e.g., for telemetry measurements, videos, images, etc.), mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The edge devices 106 may also or alternately comprise virtualized computing resources, such as virtual machines (VMs), containers, etc. In this illustration, the edge devices 106 may be tightly coupled or loosely coupled with other devices, such as one or more input sensors and/or output instruments (not shown). Couplings can take many forms, including but not limited to using intermediate networks, interfacing equipment, connections, etc.

Edge devices 106 in some embodiments comprise respective computers associated with a particular company, organization or other enterprise. In addition, at least portions of information processing system environment 100 may also be referred to herein as collectively comprising an “enterprise.” Numerous other operating scenarios involving a wide variety of different types and arrangements of processing nodes are possible, as will be appreciated by those skilled in the art.

Note that the number of different components referred to in FIG. 1, e.g., M, N, P, Q, can each be different numbers or some of them the same numbers. Embodiments illustrated herein are not intended to be limited to any particular numbers of components.

As shown in FIG. 1, edge computing sites 104 are connected to cloud computing sites 102 via one or more communication networks 112 (also referred to herein as networks 112). Although not explicitly shown, edge devices 106 may be coupled to the edge computing sites 104 via networks 112. Networks 112 coupling the cloud computing sites 102, edge computing sites 104 and edge devices 106 are assumed to comprise a global computer network such as the Internet, although other types of private and public networks can be used, including a wide area network (WAN), a local area network (LAN), a satellite network, a telephone or cable network, a cellular network, a wireless network such as a WiFi or WiMAX network, or various portions or combinations of these and other types of networks. In some embodiments, a first type of network couples edge devices 106 to edge computing sites 104, while a second type of network couples the edge computing sites 104 to the cloud computing sites 102. Various other examples are possible.

In some embodiments, one or more of cloud computing sites 102 and one or more of edge computing sites 104 collectively provide at least a portion of an information technology (IT) infrastructure operated by an enterprise, where edge devices 106 are operated by users of the enterprise. The IT infrastructure comprising cloud computing sites 102 and edge computing sites 104 may therefore be referred to as an enterprise system. As used herein, the term “enterprise system” is intended to be construed broadly to include any group of systems or other computing devices. In some embodiments, an enterprise system includes cloud infrastructure comprising one or more clouds (e.g., one or more public clouds, one or more private clouds, one or more hybrid clouds, combinations thereof, etc.). The cloud infrastructure may host at least a portion of one or more of cloud computing sites 102 and/or one or more of the edge computing sites 104. A given enterprise system may host assets that are associated with multiple enterprises (e.g., two or more different businesses, organizations or other entities). In another example embodiment, one or more of the edge computing sites 104 may be operated by enterprises that are separate from, but communicate with, enterprises which operate the one or more cloud computing sites 102.

Although not explicitly shown in FIG. 1, one or more input-output devices such as keyboards, displays or other types of input-output devices may be used to support one or more user interfaces to each of cloud computing sites 102, edge computing sites 104 and edge devices 106, as well as to support communication between each of cloud computing sites 102, edge computing sites 104, edge devices 106, and other related systems and devices not explicitly shown.

As noted above, cloud computing sites 102 host cloud-hosted applications 108 and edge computing sites 104 host edge-hosted applications 110. Edge devices 106 may exchange information with cloud-hosted applications 108 and/or edge-hosted applications 110. For example, edge devices 106 or edge-hosted applications 110 may send information to cloud-hosted applications 108. Edge devices 106 or edge-hosted applications 110 may also receive information (e.g., such as instructions) from cloud-hosted applications 108.

It should be noted that, in some embodiments, requests and responses or other information may be routed through multiple edge computing sites. While FIG. 1 shows an embodiment where each edge computing site 104 is connected to cloud computing sites 102 via the networks 112, this is not a requirement. In other embodiments, one or more of edge computing sites 104 may be connected to one or more of cloud computing sites 102 via one or more other ones of edge computing sites 104 (e.g., edge computing sites 104 may be arranged in a hierarchy with multiple levels, possibly including one or more edge data centers that couple edge computing sites 104 with cloud computing sites 102).

It is to be appreciated that multicloud computing network 103, edge computing network 105, and edge devices 106 may be collectively and illustratively referred to herein as a “multicloud edge platform.” In some embodiments, edge computing network 105 and edge devices 106 are considered a “distributed edge system.” Still further shown in FIG. 1, information processing system environment 100 comprises an application monitoring engine 120. Application monitoring engine 120 is generally shown connected to edge computing network 105 meaning that application monitoring engine 120 is connected to each of edge computing sites 104, edge-hosted applications 110, edge devices 106, and one or more other components (not expressly shown in FIG. 1) that are part of or otherwise associated with edge computing network 105. In some embodiments, an edge orchestration and scheduling platform (e.g., a cloud native (CN) orchestrator) and one or more edge zone controllers may be part of edge computing network 105 and, accordingly, connected to application monitoring engine 120. Application monitoring engine 120 is also connected to each of cloud computing sites 102, cloud-hosted applications 108, and one or more other components (not expressly shown in FIG. 1) that are part of or otherwise associated with multicloud computing network 103 via edge computing network 105 and the one or more communication networks 112, and/or through one or more other networks.

While application monitoring engine 120 is shown as a single block external to edge computing network 105, it is to be appreciated that, in some embodiments, parts or all of application monitoring engine 120 may be implemented within edge computing network 105 and reside on one or more of the components that comprise edge computing network 105. For example, modules that constitute application monitoring engine 120 may be deployed on one or more of edge computing sites 104, edge devices 106, and any other components not expressly shown. In some alternative embodiments, one or more modules of application monitoring engine 120 can be implemented on one or more cloud computing sites 102. Also, it is to be understood that while application monitoring engine 120 refers to application monitoring, the term application is intended to be broadly construed to include applications, microservices, and other types of services.

As will be explained in greater detail herein, application monitoring engine 120 is configured to provide predictive anomaly detection and fault isolation functionalities in the multicloud edge platform embodied via multicloud computing network 103 and edge computing network 105. In some embodiments, application monitoring engine 120 utilizes artificial intelligence (AI) techniques to provide a continuous and scalable monitoring system for detecting service failures and impairments with a high rate of true positives. In some embodiments, application monitoring engine 120 operates with multicloud edge platform functions (i.e., functions associated with components in information processing system environment 100) to achieve the predictive anomaly detection and fault isolation functionalities.

More particularly, application monitoring engine 120 is configured to provide reliable detection of anomalous performance at massive scale in a distributed edge system by monitoring running applications (e.g., edge-hosted applications 110, as well as cloud-hosted applications 108, which may comprise applications, microservices, and/or other services) across the platform in a distributed framework. The predictive anomaly detection and fault isolation functionalities described herein may be referred to as edge platform lifecycle functions.

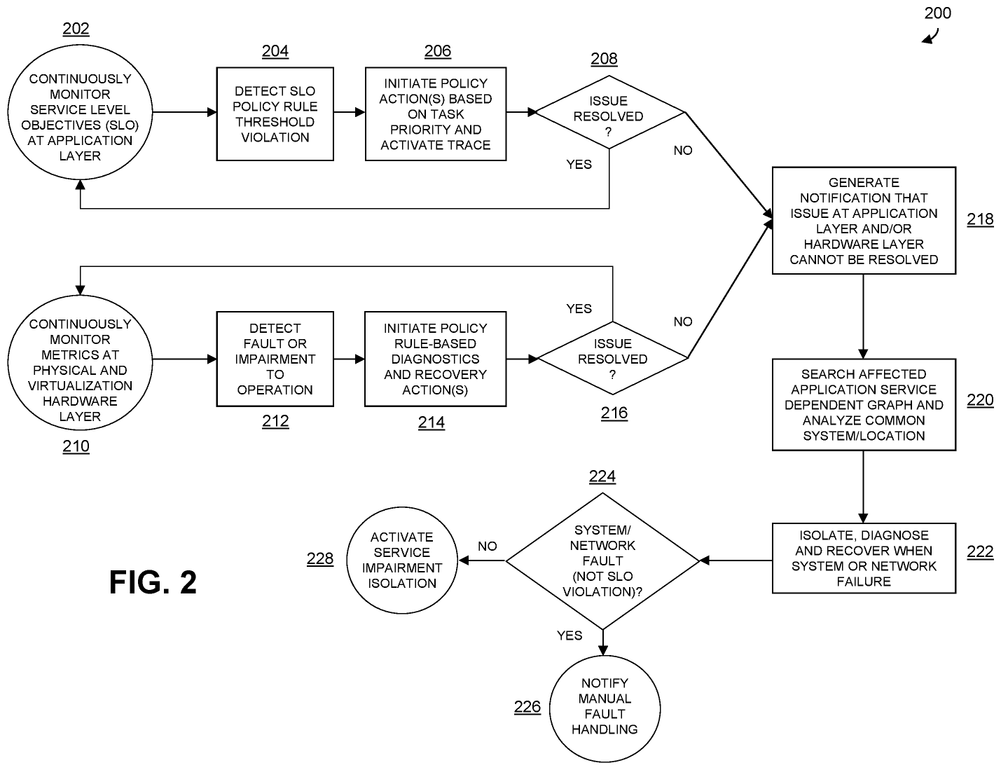

Furthermore, application monitoring engine 120 is configured to provide system fault isolation by monitoring an operational state or a threshold crossing since a hard failure results in a definite state profile (e.g., all application services fail on one system, etc.). Network failures can be intermittent or partial but with performance indicators and thresholds, these failures can be detected and isolated and remediation can be to relocate applications. System/network fault isolation is managed by orchestration and/or edge controller functions and, if operational state cannot be resolved, application monitoring engine 120 will initiate and reschedule/assign application tasks. However, anomalies resulting in service impaired operation can be very difficult to determine if the failure is systemic and needs to be addressed proactively or is transitory with no need to address. Further details of application monitoring engine 120 will be explained below in the context of FIG. 2.

Referring still to FIG. 1, in some embodiments, edge data from edge devices 106 may be stored in a database or other data store (not shown), either locally at edge computing sites 104 and/or in processed or transformed format at different endpoints (e.g., cloud computing sites 102, edge computing sites 104, other ones of edge devices 106, etc.). The database or other data store may be implemented using one or more storage systems that are part of or otherwise associated with one or more of cloud computing sites 102, edge computing sites 104, and edge devices 106. By way of example only, the storage systems may comprise a scale-out all-flash content addressable storage array or other type of storage array. The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Cloud computing sites 102, edge computing sites 104, edge devices 106, and application monitoring engine 120 in the FIG. 1 embodiment are assumed to be implemented using processing devices, wherein each such processing device generally comprises at least one processor and an associated memory.

It is to be appreciated that the particular arrangement of cloud computing sites 102, edge computing sites 104, edge devices 106, cloud-hosted applications 108, edge-hosted applications 110, communications networks 112, and application monitoring engine 120 illustrated in the FIG. 1 embodiment is presented by way of example only, and alternative arrangements can be used in other embodiments.

It is to be understood that the particular set of components shown in FIG. 1 is presented by way of illustrative example only, and in other embodiments additional or alternative components may be used. Thus, another embodiment may include additional or alternative systems, devices and other network entities, as well as different arrangements of modules and other components.

Cloud computing sites 102, edge computing sites 104, edge devices 106, application monitoring engine 120, and other components of the information processing system environment 100 in the FIG. 1 embodiment are assumed to be implemented using one or more processing platforms each comprising one or more processing devices having a processor coupled to a memory. Such processing devices can illustratively include particular arrangements of compute, storage, and network resources.

Cloud computing sites 102, edge computing sites 104, edge devices 106, application monitoring engine 120, or components thereof, may be implemented on respective distinct processing platforms, although numerous other arrangements are possible. For example, in some embodiments at least portions of edge devices 106, edge computing sites 104, and application monitoring engine 120 may be implemented on the same processing platform. One or more of edge devices 106 can therefore be implemented at least in part within at least one processing platform that implements at least a portion of edge computing sites 104. In other embodiments, one or more of edge devices 106 may be separated from but coupled to one or more of edge computing sites 104. Various other component coupling arrangements are contemplated herein.

The term “processing platform” as used herein is intended to be broadly construed so as to encompass, by way of illustration and without limitation, multiple sets of processing devices and associated storage systems that are configured to communicate over one or more networks. For example, distributed implementations of information processing system environment 100 are possible, in which certain components of the system reside in one data center in a first geographic location while other components of the system reside in one or more other data centers in one or more other geographic locations that are potentially remote from the first geographic location. Thus, it is possible in some implementations of the system for cloud computing sites 102, edge computing sites 104, edge devices 106, and application monitoring engine 120, or portions or components thereof, to reside in different data centers. Distribution as used herein may also refer to functional or logical distribution rather than to only geographic or physical distribution. Numerous other distributed implementations are possible.

In some embodiments, information processing system environment 100 may be implemented in part or in whole using a Kubernetes container orchestration system. Kubernetes is an open-source system for automating application deployment, scaling, and management within a container-based information processing system comprised of components referred to as pods, nodes and clusters. Types of containers that may be implemented or otherwise adapted within the Kubernetes system include, but are not limited to, Docker containers or other types of Linux containers (LXCs) or Windows containers. Kubernetes has become the prevalent container orchestration system for managing containerized workloads. It is rapidly being adopted by many enterprise-based IT organizations to deploy its application programs (applications). By way of example only, such applications may include stateless (or inherently redundant applications) and/or stateful applications. While the Kubernetes container orchestration system is used to illustrate various embodiments, it is to be understood that alternative container orchestration systems, as well as information processing systems other than container-based systems, can be utilized.

Some terminology associated with the Kubernetes container orchestration system will now be explained. In general, for a Kubernetes environment, one or more containers are part of a pod. Thus, the environment may be referred to, more generally, as a pod-based system, a pod-based container system, a pod-based container orchestration system, a pod-based container management system, or the like. As mentioned above, the containers can be any type of container, e.g., Docker container, etc. Furthermore, a pod is typically considered the smallest execution unit in the Kubernetes container orchestration environment. A pod encapsulates one or more containers. One or more pods are executed on a worker node. Multiple worker nodes form a cluster. A Kubernetes cluster is managed by at least one manager node. A Kubernetes environment may include multiple clusters respectively managed by multiple manager nodes. Furthermore, pods typically represent the respective processes running on a cluster. A pod may be configured as a single process wherein one or more containers execute one or more functions that operate together to implement the process. Pods may each have a unique Internet Protocol (IP) address enabling pods to communicate with one another, and for other system components to communicate with each pod. Still further, pods may each have persistent storage volumes associated therewith. Configuration information (configuration objects) indicating how a container executes can be specified for each pod. It is to be appreciated, however, that embodiments are not limited to Kubernetes container orchestration techniques or the like.

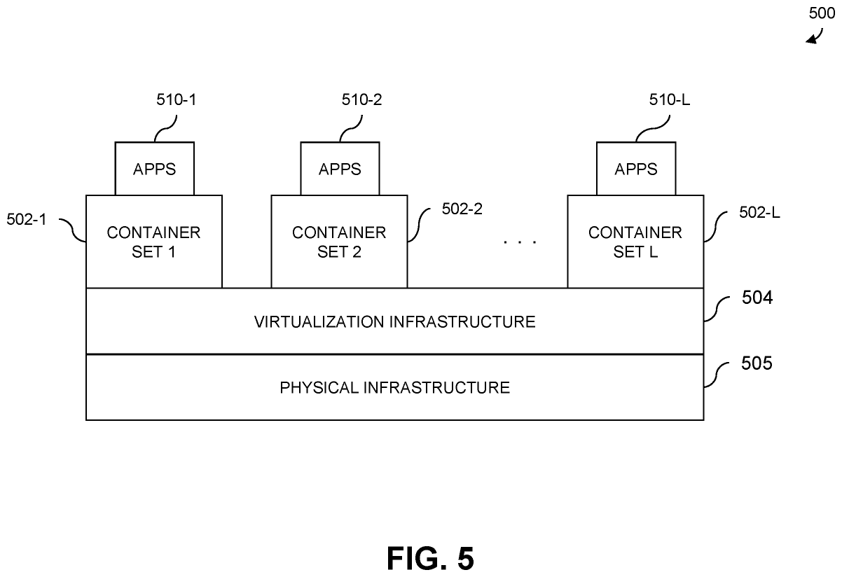

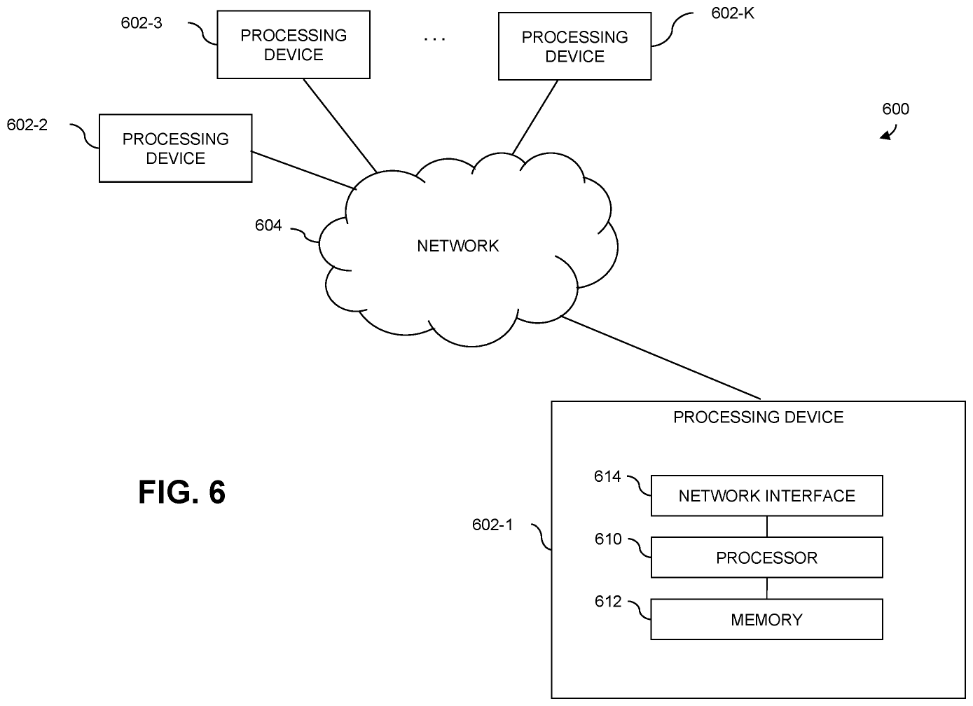

Additional examples of processing platforms utilized to implement cloud computing sites 102, edge computing sites 104, edge devices 106, application monitoring engine 120, and other components of the information processing system environment 100 in illustrative embodiments will be described in more detail below in conjunction with FIGS. 5 and 6.

As explained above, when an information processing system environment is distributed in nature such as, for example, information processing system environment 100, anomaly detection and fault isolation can be significantly hampered. In addition, when the applications that are executed in the information processing system environment, e.g., cloud-hosted applications 108 and edge-hosted applications 110, are microservices, the nature of microservices can greatly exacerbate anomaly detection and fault isolation. In some embodiments, microservices are loosely coupled applications that are typically independently deployable, communicate through lightweight protocols, and tend to be created around enterprise capabilities. However, in broad terms, a microservice can be any application software code that performs a function. It is realized herein that microservice causal issues are difficult to identify based on output metrics. Also, microservice failure modes are more likely to be impaired versus hard failures. Microservice causal issues can be from a wide array of issues with the impaired service with poorest performance not being the causal issue. Still further, due to the nature of microservices, sufficient resources typically cannot be devoted to detection, causal analysis, and remediation of service impairments and failures.

Referring now to FIG. 2, an exemplary application monitoring process 200 (also referred to herein simply as process 200) is depicted for predictive anomaly detection and fault isolation according to an illustrative embodiment. It is to be appreciated that process 200, in some embodiments, is implemented via application monitoring engine 120 of FIG. 1. However, steps in process 200 can be implemented in one or more components of edge computing network 105 and, and multicloud computing network 103 as may be needed. Process 200 according to illustrative embodiments overcomes the above and other drawbacks with existing anomaly detection and fault isolation, especially in a multicloud edge platform wherein at least some of the applications executing therein are microservices.

More particularly, as will be explained in detail below, process 200 monitors and attempts to detect issues at both the application layer and the physical and virtualization hardware layer of the underlying multicloud edge platform (e.g., information processing system environment 100). In particular, steps 202 through 208 operate on the application layer (application-level), while steps 210 through 216 operate on the physical and virtualization hardware layer (hardware-level).

For example, at the application layer, application telemetry service level objective (SLO) monitoring is performed by process 200 with cloud native techniques using the commonly available Kubernetes framework with a container side car approach (which can be adapted to implement at least part of application monitoring engine 120). The application telemetry can collect multiple performance metrics at the application level for end-to-end performance including, but not limited to: (i) a response latency metric that specifies the elapsed time duration for the application or microservice to respond to a request; (ii) a performance metric that specifies a count of successful responses divided by all responses; and (iii) an availability metric that specifies the percent of time over a time period that the application or microservice is operational. These performance SLOs are part of a typical Kubernetes orchestration platform and largely available through standard observability frameworks.

Accordingly, with reference to FIG. 2, step 202 continuously monitors SLOs at the application layer of the multicloud edge platform.

Step 204 then detects any SLO policy rule threshold violations. For example, a violation is detected when one or more of the above-mentioned response latency metric, the performance metric, or the availability metric indicates a value that is above/below an agreed-upon (e.g., in a use case where an enterprise that deploys at least part of the multicloud edge platform is hosting one or more applications of a customer) or otherwise predetermined threshold.

Responsive to step 204 determining a SLO policy rule threshold violation, step 206 initiates one or more policy actions based on a task priority and activates a trace of the violating microservice or task.

Step 208 determines whether or not the detected application layer issue is resolved. If yes, process 200 returns to step 202 for continuous application layer monitoring.

Turning now to the physical and virtualization hardware layer, resource telemetry monitoring is performed by process 200, in accordance with one or more illustrative embodiments, by deploying software modules (i.e., agents) at multiple components of the multicloud edge platform. By way of example only, a Rust programming language-based agent sub-system referred to as a resource control monitor (RCM) can be deployed to run at the operating system (OS) level on an edge endpoint (e.g., edge computing site 104, edge device 106, etc.) where the workload will execute. For example, during initial application services scheduling, an RCM agent is given a list of application services processes to monitor. The RCM agent monitors compute resource (e.g., CPU, GPU, etc.) utilization and memory resource utilization on the edge endpoint at variable granular timeframes during normal operation (e.g., at five second intervals) and reports the resource utilization data to an edge zone controller (which can be adapted to implement at least part of application monitoring engine 120). The RCM agent can also measure down to 500 millisecond intervals in a trouble isolation mode. In some embodiments, the RCM agent sends the resource utilization data using a Quick UDP Internet Connections (QUIC) protocol to an edge zone controller. While embodiments are not intended to be limited thereto, the QUIC protocol is used since reliable delivery is not needed but rather highly time sensitive delivery. Also, a minimal state protocol such as QUIC is desirable as both physical and virtual infrastructure is monitored leading to a large number of connections reporting resource telemetry information.

Thus, step 210 of process 200 continuously monitors metrics at a physical and virtualization hardware layer (or level) of the multicloud edge platform. Step 210 may be performed simultaneously, substantially simultaneously, or otherwise contemporaneously with the continuous SLO violation monitoring at the application layer provided at step 202, however, alternative embodiments are not intended to be limited thereto.

Next, in step 212, process 200 detects faults and/or impairments to operations at the physical and virtualization hardware layer. Step 214 initiates predetermined policy rule-based diagnostics and one or more recovery actions responsive to any faults and/or impairments being detected. Step 216 then determines whether or not the detected hardware layer issue is resolved.

If yes, process 200 returns to step 210.

In response to a determination at step 208 that an issue at the application layer cannot be resolved and/or a determination at step 216 that an issue at the hardware layer cannot be resolved, step 218 generates a notification that specifies the unresolved issue(s).

Step 220 searches affected application service dependent graphs and analyzes common systems/locations. More particularly, applications comprising microservices are often representable as directed acyclic graphs (DAG). As such, a DAG representation of a microservice in which an issue is detected (affected application) can be searched for attempting to pinpoint the source of the issue at the application layer (SLO violation).

Step 222 isolates, diagnoses, and recovers when the unresolved issue is a system or network (hardware layer) failure.

Step 224 determines whether or not the issue has been resolved and, if not and it is a system/network fault, step 226 notifies an administrator to initiate a manual fault handling procedure. However, if the unresolved issue is at the application layer, step 228 activates further processing as needed, e.g., a service impairment isolation procedure.

In accordance with one or more illustrative embodiments, process 200 can be implemented in conjunction with a predictive anomaly detection-based algorithm.

More particularly, at an edge zone controller, a sub-system agent can be deployed to analyze SLO cloud native observability metrics from the applications (step 202), as well as resource metrics from the RCM agent (step 210) to predictively detect application service impairment and/or associated infrastructure that are approaching or at failure. The overall cloud native system executes an application programming interface (API) declarative orchestration framework to detect and resolve issues and the edge zone controller will monitor this activity. These two functions are attempting to detect and remediate hard system faults such as network failure or system platform failure. The predictive anomaly detection-based algorithm also continuously monitors telemetry streams where a threshold cloud native SLO metric has a repeated SLO metric violation over a predetermined period of time. This triggers the predictive anomaly detection-based algorithm to take multiple actions comprising:
(i) collects application, service level, and resource metrics and conducts an attention transformer associative analysis for the time period of failure including the service dependency graphs as assigned by the orchestration/scheduling system;
(ii) initiates an active application trace and collects data (resource level and application level); and
(iii) executes an attention transformer associative analysis over a prior predetermined time period (e.g., 24 hours) and during the trace.

If the predictive anomaly detection-based algorithm confirms an anomalous impairment issue, it activates a service impairment isolation procedure.

It is realized herein that in the context of a lifecycle domain level framework, the cloud native orchestrator and the edge zone controller react independently to resolving failures that are detected (i.e., cloud native orchestrator at the application layer and edge zone controller at the physical/virtualization hardware layer) and a resolution is taken based on deterministic steps. The predictive anomaly detection-based algorithm according to illustrative embodiments augments these processes to go beyond hardware system/network failures to isolate if a service (application, microservice) impairment actually exists and needs to be addressed.

In one or more illustrative embodiments, the predictive anomaly detection-based algorithm is configured to implement one or more AI techniques to detect anomalous behavior. Both the edge zone controller and cloud native orchestrator are monitoring the system and producing observability data on all applications, while the predictive anomaly detection-based algorithm obtains that observability data and/or performs monitoring from the edge zone controller. Note the predictive anomaly detection-based algorithm does not necessarily have to actively monitor all functions continuously. That is, in some embodiments, low priority applications such as batch and background tasks are not monitored by the predictive anomaly detection-based algorithm, nor are short-lived tasks. These low priority and background jobs are producing telemetry data and are being managed through other processes that the predictive anomaly detection-based algorithm can support. The exclusion of low priority and short-lived jobs greatly reduces the number of applications actively being monitored and managed by the predictive anomaly detection-based algorithm. In addition, the predictive anomaly detection-based algorithm monitors across the entire microservices span. This is end-end at an application-level view (i.e., measure start service and end service for SLO cloud native metrics). SLO cloud native metrics are collected across the entire application (all services) but only used by subsequent troubleshooting steps.

In some embodiments, the predictive anomaly detection-based algorithm can be thought of as a parallel monitoring function. Its goal is to predictively monitor performance of the application response latency SLO cloud native metric. For example, the predictive anomaly detection-based algorithm monitors the overall application (and not each microservice when an application comprises multiple microservices). Anomalies are difficult to detect as normal patterns dominate and make training an existing recurrent neural network (RNN) model to recognize these behaviors very challenging. Complex temporal patterns frustrate these systems which are looking for informative representations. Likewise, existing simple threshold crossing systems require a hard failure to detect the problem. Many issues in the software space have a soft failure or impairment which is virtually undetectable with threshold crossing or traditional RNN based informative representation comparison.

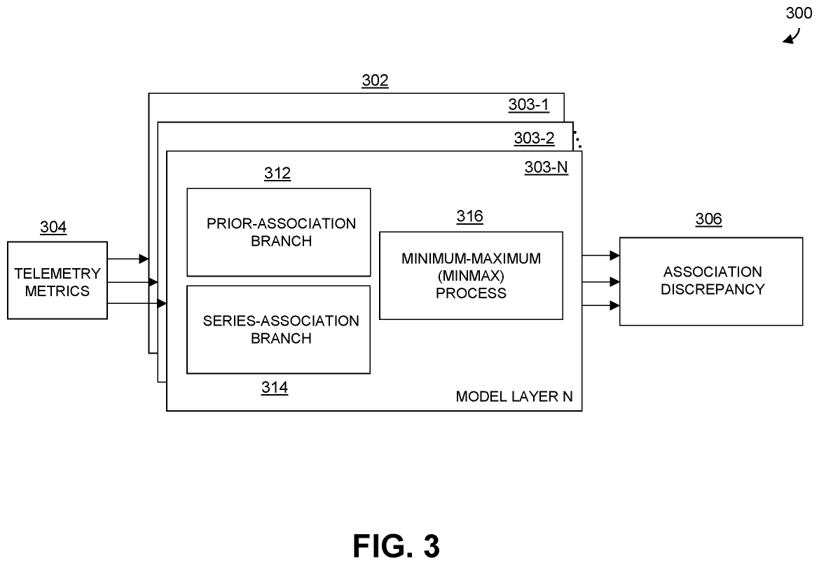

FIG. 3 illustrates an exemplary implementation of a predictive anomaly detection-based algorithm in the form of a predictive anomaly detection transformer (PADT) system 300. More particularly, as depicted, PADT system 300 includes an AI model 302 comprising multiple layers 303-1, 303-2, . . . , 303-N(hereinafter referred to collectively as layers 303 or individually as layer 303) to which telemetry metrics 304 (e.g., data obtained through monitoring steps described above in the context of process 200) are input and from which outputs are generated and sent to an association discrepancy module 306.

AI model 302 uses a temporal datapoint association method with two branches at each layer 303, i.e., one branch 312 for prior-association of time series datapoints and another branch 314 for series-association, wherein a distribution of a datapoint is described with its relations to other datapoints and a series of datapoints. This provides a more expressive approach. AI model 302 also leverages the realization that an anomaly does not build strong relative associations outside time windows of adjacent datapoints (where normal behavior does). In one or more illustrative embodiments, AI model 302 utilizes unsupervised machine learning and is based on an anomaly transformer model primarily using natural language programming (NLP) techniques. One non-limiting example of an anomaly transformer model that is adapted according to illustrative embodiments described herein is described in J. Xu et al., “Anomaly Transformer: Time Series Anomaly Detection with Association Discrepancy,” International Conference on Learning Representations (ICLR) June 2022, the disclosure of which is incorporated by reference herein in its entirety.

While embodiments are not limited to any given anomaly transformer, illustrative embodiments modify the above-referenced anomaly transformer approach to capture profiles but also detect anomalous behavior and use a non-gaussian approach by capturing an entire population of time window representation for the anomaly-attention for prior-association modeling. Illustrative embodiments also use four heads versus eight heads to conserve computation resources. The two branches 312 (prior-association) and 314 (series-association) create two distributions for which divergence is identified by using a Kullback-Leibler divergence technique relative entropy (information gain). AI model 302 utilizes a minimax (minimize-maximize) process 316 to expand the difference in reconstruction and guide the AI model 302 to finer areas of anomalies. Association discrepancy module 306 creates association discrepancy scores. A sliding window based on the application is used to alert for a predictive anomaly, which helps to minimize false positives. For example, in one illustrative embodiment, a default time window of three detected anomalous periods over one minute in a 30-minute period is used to trigger analysis. This can be adjusted down or up based on the volume of information being produced by the application.

Accordingly, PADT system 300 provides early detection of an anomaly prior to an issue manifesting into a major performance/resource issue. More particularly, in an exemplary embodiment, prior-association branch 312 is configured to compute: P′=scale([(1/sqrt(2πσ))exp(−(j−i)\hat{ }2/2σ2])_{i,jc(1, . . . , N)} wherein weights are normalized by dividing by the sum of records, e.g., N=100. Further, in the exemplary embodiment, series-association branch 314 is configured to compute: S′=Softmax(QK^{T}/sqrt(d_{modelk})). Still further, in the exemplary embodiment, association discrepancy module 306 is configured to compute: P,S,X=(1/L)Σ(KL(P′∥S′)+KL(S′∥P′)). A grad-stop gradient may be used to constrain the prior and series associations. It is to be noted that Q represents a query of the anomaly detection transformer, K represents the record key of the observation, V represents the value of the observation, and the algorithm defaults to four heads for operation in the exemplary embodiment.

Advantageously, PADT system 300 provides a mechanism of analyzing datapoint time dependent associations and series association (data characteristic or waveform) and detecting when they are in high alignment and a potential anomaly in operation is occurring. This is highly scalable and highly effective, for example, with expected association discrepancy (F1) scores of above 92.

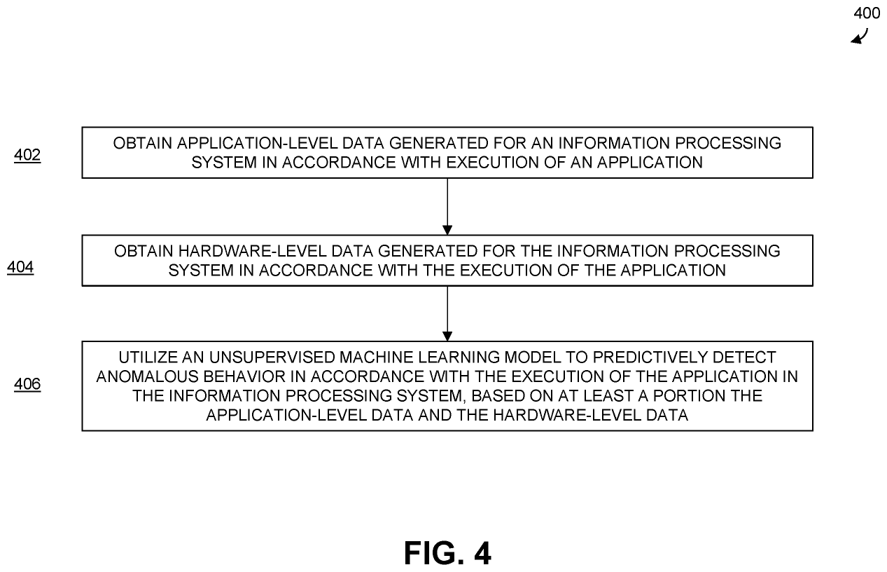

FIG. 4 shows a process flow 400 for application monitoring with predictive anomaly detection and fault isolation according to an illustrative embodiment. In one or more exemplary embodiments, process flow 400 is performed in accordance with information processing system environment 100 (i.e., multicloud edge platform) in conjunction with application monitoring engine 120 using process 200 and/or implementing PADT system 300.

As shown, process flow 400 begins in step 402 which obtains application-level data generated for an information processing system in accordance with execution of an application. Step 404 obtains hardware-level data generated for the information processing system in accordance with the execution of the application. Step 406 then utilizes an unsupervised machine learning model to predictively detect anomalous behavior in accordance with the execution of the application in the information processing system, based on at least a portion the application-level data and the hardware-level data. Note that fault isolation may be initiated in addition to predicting anomalous behavior.

Advantageously, as explained herein, illustrative embodiments use an unsupervised technique and an advanced AI model to create an ability to predict anomalous behavior before complete failure. This is more beneficial than threshold crossing techniques and can eliminate so-called “silent failure” (where a system and/or application does not completely fail but continues to operate with one or more issues that adversely impact service level objectives as well as other operational criteria. Illustrative embodiments also enable the ability to achieve root cause and remediation in a timely manner.

Further, illustrative embodiments can advantageously determine anomalous behavior profiles even when very sparse based on relative behavior of time series datapoints and an overall time series characteristic used for overall profiling and analysis.

Illustrative embodiments also advantageously provide an observability framework that collects multiple types of SLO metrics and can flexibly use any of multiple metrics in anomaly detection or service impairment isolation.

Still further, illustrative embodiments advantageously provide efficient monitoring by receiving information from the orchestration/scheduling system and policy sets by end user application owners to discriminate between hard system faults, impairments or false positives and normal operation. Such application monitoring functionalities can be performed without direct control by human personnel but rather utilize online unsupervised training.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for application monitoring with predictive anomaly detection and fault isolation will now be described in greater detail with reference to FIGS. 5 and 6. Although described in the context of information processing system environment 100, these platforms may also be used to implement at least portions of other information processing systems in other embodiments.

FIG. 5 shows an example processing platform comprising infrastructure 500. Infrastructure 500 comprises a combination of physical and virtual processing resources that may be utilized to implement at least a portion of the information processing system environment 100 in FIG. 1. Infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

Infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 may comprise respective VMs, respective sets of one or more containers, or respective sets of one or more containers running in VMs.

In some implementations of the FIG. 5 embodiment, the VMs/container sets 502 comprise respective VMs implemented using virtualization infrastructure 504 that comprises at least one hypervisor. A hypervisor platform may be used to implement a hypervisor within the virtualization infrastructure 504, where the hypervisor platform has an associated virtual infrastructure management system. The underlying physical machines may comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system environment 100 may each run on a computer, server, storage device or other processing platform element. A given such element may be viewed as an example of what is more generally referred to herein as a “processing device.” Infrastructure 500 shown in FIG. 5 may represent at least a portion of one processing platform. Another example of such a processing platform is processing platform 600 shown in FIG. 6.

The processing platform 600 in this embodiment comprises a portion of system 60 and includes a plurality of processing devices, denoted 602-1, 602-2, 602-3, . . . 602-K, which communicate with one another over a network 604.

The network 604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 602-1 in the processing platform 600 comprises a processor 610 coupled to a memory 612.

The processor 610 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 612 may comprise random access memory (RAM), read-only memory (ROM), flash memory or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and information processing system environment 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for application monitoring with predictive anomaly detection and fault isolation as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, edge computing environments, applications, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing platform comprising at least one processor coupled to at least one memory, the at least one processing platform, when executing program code, is configured to:
obtain application-level data generated for an information processing system in accordance with execution of an application;
obtain hardware-level data generated for the information processing system in accordance with the execution of the application; and
utilize an unsupervised machine learning model to predictively detect anomalous behavior in accordance with the execution of the application in the information processing system, based on at least a portion the application-level data and the hardware-level data.

2. The apparatus of claim 1, wherein the processing platform, when executing program code, is further configured to initiate fault isolation in accordance with the execution of the application.

3. The apparatus of claim 1, wherein the application-level data comprises a set of metrics associated with one or more service level objectives for the execution of the application and comprise one or more of an application response latency metric, an application performance metric, and an application availability metric.

4. The apparatus of claim 1, wherein the hardware-level data comprises a set of metrics associated with resource utilization in the information processing system during the execution of the application.

5. The apparatus of claim 1, wherein the unsupervised machine learning model is further configured to perform an attention transformer associative analysis on at least a portion the application-level data and the hardware-level data over a given time window to predictively detect the anomalous behavior.

6. The apparatus of claim 5, wherein the attention transformer associative analysis procedure further comprises a prior-association branch and a series-association branch.

7. The apparatus of claim 6, wherein the prior-association branch generates a first distribution that describes a datapoint from the portion of the application-level data and the hardware-level data over the given time window in relation to one or more prior datapoints from the portion of the application-level data and the hardware-level data over the given time window.

8. The apparatus of claim 7, wherein the series-association branch generates a second distribution that describes a datapoint from the portion of the application-level data and the hardware-level data over the given time window in relation to a series of datapoints from the portion of the application-level data and the hardware-level data over the given time window.

9. The apparatus of claim 8, wherein the attention transformer associative analysis is further configured to identify a divergence between the first distribution and the second distribution.

10. The apparatus of claim 9, wherein the attention transformer associative analysis is further configured to compute an association discrepancy score based on the divergence between the first distribution and the second distribution.

11. The apparatus of claim 10, wherein the association discrepancy score is indicative of the anomalous behavior.

12. The apparatus of claim 10, wherein the given time window is adjustable to compute an association discrepancy score indicative of future anomalous behavior.

13. The apparatus of claim 1, wherein the application executed by the information processing system comprises at least one microservice.

14. The apparatus of claim 1, wherein the information processing system comprises a distributed edge system.

15. The apparatus of claim 14, wherein the distributed edge system is part of a multicloud edge platform.

16. A computer program product comprising a non-transitory processor-readable storage medium having stored therein program code of one or more software programs, wherein the program code when executed by at least one processing device causes the at least one processing device to:
obtain application-level data generated for an information processing system in accordance with execution of an application;
obtain hardware-level data generated for the information processing system in accordance with the execution of the application; and
utilize an unsupervised machine learning model to predictively detect anomalous behavior in accordance with the execution of the application in the information processing system, based on at least a portion the application-level data and the hardware-level data.

17. The computer program product of claim 16, wherein the unsupervised machine learning model is further configured to perform an attention transformer associative analysis on at least a portion the application-level data and the hardware-level data over a given time window to predictively detect the anomalous behavior.

18. The computer program product of claim 17, wherein the attention transformer associative analysis procedure further comprises a prior-association branch and a series-association branch.

19. A method comprising:
obtaining application-level data generated for an information processing system in accordance with execution of an application;
obtaining hardware-level data generated for the information processing system in accordance with the execution of the application; and
utilizing an unsupervised machine learning model to predictively detect anomalous behavior in accordance with the execution of the application in the information processing system, based on at least a portion the application-level data and the hardware-level data;
wherein the obtaining and utilizing steps are implemented on a processing platform comprising at least one processor, coupled to at least one memory, executing program code.

20. The method of claim 19, wherein the unsupervised machine learning model is further configured to perform an attention transformer associative analysis on at least a portion the application-level data and the hardware-level data over a given time window to predictively detect the anomalous behavior.
